(19) United States
(12) Patent Application Publication
(10) Pub. No.: US 2026/0298272 A1
(43) Pub. Date: Oct. 1, 2026

(54) AUTOMATIC MULTI-BOLT BAYONET LOCK SYSTEM WITH A SINGLE MECHANISM IN THE BAYONET AND RADIAL AND AXIAL LOCKING FUNCTION

(71) Applicant: ISTANBUL TEKNIK UNIVERSITESI, Instanbul (TR)

(72) Inventor: Ahmet Kagizman, Atasehir/Instanbul (TR)

(21) Appl. No.: 19/481,203

(22) PCT Filed: May 2, 2024
(86) PCT No.: PCT/TR2024/050424

§ 371 Date: Nov. 4, 2025

(30) Foreign Application Priority Data
May 4, 2023 (TR) 2023/004971

(51) Int. Cl. F16B 7/20

(52) U.S. Cl. CPC F16B 7/20

(57) ABSTRACT

The invention relates to an automatic multi-bolt bayonet lock system with a single mechanism in a bayonet, with a radial and axial locking function that does not require manual alignment by using the number of lock bolts and lock sliding angle appropriate to the lock diameter and depth.

### TECHNICAL FIELD OF THE INVENTION

The invention relates to an automatic multi-bolt bayonet lock system with a single mechanism in a bayonet, with a radial and axial locking function that does not require manual alignment by using the number of lock bolts and lock slide angle appropriate to the lock diameter and depth.

### THE STATE OF THE ART

In the most advanced designed bayonet lock mechanisms, semi-automatic lock systems with manual angular alignment are used today. In less developed bayonet locking mechanisms, radial and axial locking cannot be done with a single mechanism due to using separate springs for each locking bolt.

In the state of the art, the most advanced bayonet lock mechanisms are semi-automatic and require manual angular alignment. The reason for this situation is correct number of lock bolts is not used for the diameter, depth, and lock slide angle used in the device's design, or a design is not made in which the correct number of lock bolts can be used. In addition, manufacturing the current design of the bayonet lock system of the device in question involves high costs and technical difficulties with both machining and precision casting methods. The reason for this, then, is their monolithic body designs. The lock mechanisms, which provide enhanced precision in lock slide and alignment through its multi-part body design, can be manufactured with relative ease and at a low cost from a technical standpoint.

In the state of the art, there are many studies, patents and/or utility model applications regarding lock mechanisms.

The invention, which is the subject of the patent application numbered “CA2347042” in the state of the art relates to a connection mechanism and, in particular, to a self-locking bayonet-type connection mechanism in which a locking sleeve placed following the axial placement of one connection part half into the other connection part. It aims to prevent unintentional disconnection of electrical, hydraulic and pneumatic power connectors. Production is made possible with higher tolerance values. After locking, fluid-tightness is ensured by providing a tightening force.

The invention, which is the subject of the patent application numbered “U.S. Pat. No. 5,665,488” in the state of the art relates to a system that combines the first connector body with the second connector body. The invention is to provide a connector system that is robust, cost-effective, and simple to manufacture and allows the positive locking connection to provide rapid one-handed mating with user approval.

In the state of the art, there is no automatic locking design that does not require manual alignment by using the number of lock bolts and lock slide angle appropriate to the lock diameter and depth. For this reason, there is a need to develop multi-piece body designs that enable the manufacture of thin designs that enable the automatic realisation of the miniaturised, precise, and strong locking function in the state of the art.

As a result, due to the negativities described above and the inadequacy of existing solutions on the subject, a new technology is needed in the relevant technical field.

### BRIEF DESCRIPTION AND AIMS OF THE INVENTION

The invention relates to an automatic multi-bolt bayonet lock system with a single mechanism in a bayonet, with a radial and axial locking function that does not require manual alignment by using the number of lock bolts and lock slide angle appropriate to the lock diameter and depth.

The most important aim of the invention is to provide a multi-part body design that enables the manufacture of thin designs that enable miniature, precise, and powerful locking functions to be automatically realized.

Another aim of the invention is to provide convenience to the user in machine installation by means of automatic locking that does not require manual alignment.

Another aim of the invention is to enable vertical and angular locking to be done precisely and strongly with a miniature mechanism within the lock system.

Another aim of the invention is to provide ease of manufacturing and low cost with multi-part body designs.

### DESCRIPTION OF DRAWINGS

FIG. 1 is the drawing showing the upper diagonal view of the automatic multi-bolt bayonet lock system with radial and axial locking functions, consisting of the bayonet and the lock housing, with a single mechanism in the bayonet, which is the subject of the invention.

FIG. 2 is the drawing showing the upper and lower diagonal angles of the bayonet consisting of the bayonet connector and locking mechanism, which is the subject of the invention.

FIG. 3 is the drawing showing the view of the lock mechanism, which is the subject of the invention, consisting of the lock bolt, lock arm, lock bolt bushing screw, lock arm bolt, lock base part, lock central screw, lock pin, lock pin screws, lock mechanism central disc, lock upper bearing and lock arm setscrews.

FIG. 4 is the drawing showing the view of the lock spring, lock lower bearing, lock arm bearing disc, lock lower bearing washer and lock spring connection setscrew of the lock mechanism of the invention.

FIG. 5 is the drawing showing the combined view of the lock mechanism and bayonet ring of the invention.

FIG. 6 is the drawing showing the lock housing view of the lock housing upper ring, which is the subject of the invention, consisting of the lock housing lower ring and the lock housing body part.

FIG. 7 is the drawing showing the view of the lock bolt connection hole, lateral angled front surface, and the vertical angled front surface of the lock bolt that is the subject of the invention.

FIG. 8 is the drawing showing the view of the lock arm connection holes, and lock arm slot of the lock arm that is the subject of the invention.

FIG. 9 is the drawing showing the view of the lock base part, bearing bolt connection holes, laser welding surface, central connection hole, spring connection hole, lock bolt housing, and the outer surface of the base part, which are the subject of the invention.

FIG. 10 is the drawing showing the lock arm bearing disc, central connection hole, setscrew holes, spacing shoulder, bearing countersink, and bearing housing, which are the subject of the invention.

FIG. 11 is the drawing showing the view of the lock spring lower pin and lock spring upper pin of the lock spring which is the subject of the invention.

FIG. 12 is the drawing showing the appearance of the lock mechanism central disc, central connection hole, setscrew holes, and lock pin connection holes, which are the subject of the invention.

FIG. 13 is the drawing showing the lock pin connection holes and lock pin arm of the lock pin which is the subject of the invention.

FIG. 14 is the drawing showing the view of the bayonet ring, lock radial fixing shoulders, lock slider lower surfaces, bayonet ring mounting surface and lock bolt housing, which is the subject of the invention.

FIG. 15 is the drawing showing the view of the lock housing upper ring, lock housing triangular shoulders, lock housing angles, lock slider upper surfaces, and lock housing upper ring mounting surface, which is the subject of the invention.

FIG. 16 is the drawing showing the view of the inner ring of the lock housing lower ring, the upper surfaces of the lock slider, the outer ring of the ring, the mounting surface of the lower ring of the lock housing, and the lock bolt bushing surfaces, which are the subject of the invention.

FIG. 17 is the drawing showing the view of the lock housing body part, the lower inner surface of the lock housing body part, the upper inner surface of the lock housing body part, the lock housing bolt, the lock housing mounting holes and the side surface of the lock housing bolt, which are the subject of the invention.

FIG. 18 is the drawing showing the bayonet connector, lock pin slit, bayonet connector inserting rabbet and lock facing the ring, which is the subject of the invention.

FIG. 19 is the drawing showing the view of the lock holder ribs of the lock holder that is the subject of the invention.

FIG. 20 is the drawing showing the view of the lock holder of the invention on the bayonet.

FIG. 21 is the drawing showing the unlocked position of the lock arms that are the subject of the invention.

FIG. 22 is the drawing showing the locked positions of the lock arms that are the subject of the invention.

### REFERENCE NUMBERS

1. Automatic multi-bolt bayonet lock system with radial and axial locking functions, and single mechanism in the bayonet
2. bayonet
3. lock housing
4. bayonet connector
   4.1 lock pin slit
   4.2 bayonet connector inserting rabbet
   4.3 lock facing ring
5. lock mechanism
6. lock bolt
   6.1 lock bolt connection hole
   6.2 laterally angled front surface
   6.3 vertically angled front surface
7. lock arm
   7.1 lock arm connection hole
   7.2 lock arm connection hole
   7.3 lock arm slot
8. lock bolt bushing screw
9. lock arm bolt
10. lock base part
   10.1 bushing screw hole
   10.2 laser welding surface
   10.3 central connection hole
   10.4 spring connection hole
   10.5 lock bolt housing
   10.6 base part outer surface
11. lock central screw
12. lock pin
   12.1 lock pin connection hole
   12.2 lock pin arm
13. lock pin screws
14. lock mechanism central disc
   14.1 central connection hole
   14.2 setscrew holes
   14.3 lock pin connection holes
15. lock upper bearing
16. lock arm setscrews
17. lock spring
   17.1 lock spring lower pin
   17.2 lock spring upper pin
18. lock lower bearing
19. lock arm bearing disc
   19.1 central connection hole
   19.2 setscrew holes
   19.3 spacing shoulder
   19.4 bearing countersink
   19.5 bearing housing
20. lock lower bearing washer
21. lock spring connection setscrew
22. bayonet ring
   22.1 lock radial fixing shoulder
   22.2 lock slider lower surfaces
   22.3 bayonet ring mounting surface
   22.4 lock bolt housing
23. lock housing upper ring
   23.1 lock housing triangular shoulders
   23.2 lock housing angles
   23.3 lock slider upper surfaces
   23.4 lock housing upper ring mounting surface
24. lock housing lower ring
   24.1 ring inner collet
   24.2 lock slider upper surfaces
   24.3 ring outer collet
   24.4 lock housing lower ring mounting surface
   24.5 lock bolt bushing surfaces
25. lock housing body part
   25.1 lock housing body part lower inner surface
   25.2 lock housing body part upper inner surface
   25.3 lock housing shoulders
   25.4 lock housing mounting holes
26. lock holder
   26.1 lock holder ribs
h1 lock bolt full height
h2 lock bolt cut height
h3 lock housing upper ring height
h4 lock housing lower ring height excluding ring inner collet and ring outer collet
w1 lock bolt full width
w2 lock bolt cut width
L1 lock bolt full length
L2 lock bolt cut length
L3 lock arm centre distance
L4 lock arm centre distance
r1 lock turning inner diameter
r2 lock turning outer diameter
r3 lock arm centre radius
r4 lock unlocked radius
Q1 lock section angle
Q2 lock partial angle
Q3 lock arm angle in the unlocked position
Q4 lock pin angle in the unlocked position
Q5 lock arm angle in the locked position
Q6 lock pin angle in the locked position

### DETAILED DESCRIPTION OF THE INVENTION

The invention relates to an automatic multi-bolt bayonet lock system (1) with a single mechanism in a bayonet, with a radial and axial locking function that does not require manual alignment by using the number of lock bolts and lock sliding angle appropriate to the lock diameter and depth.

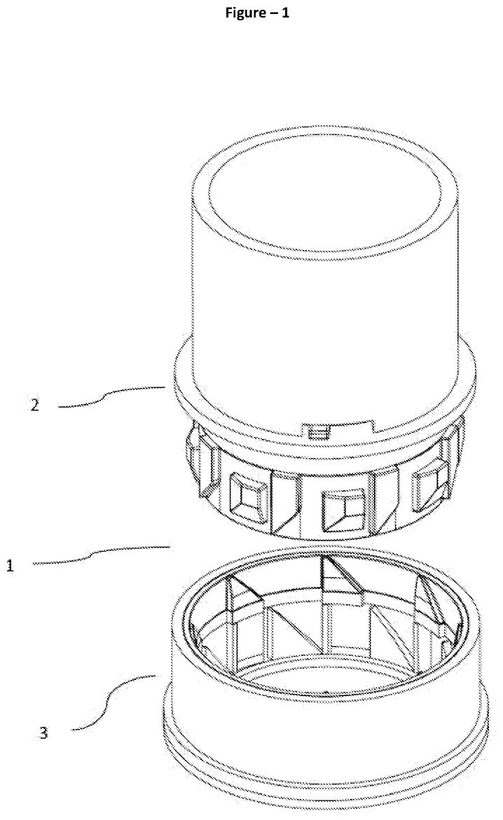

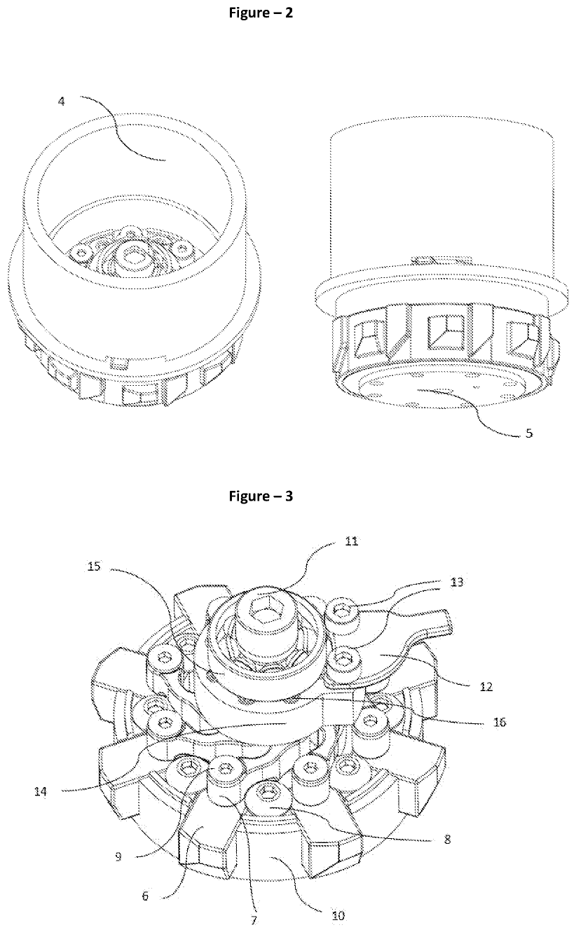

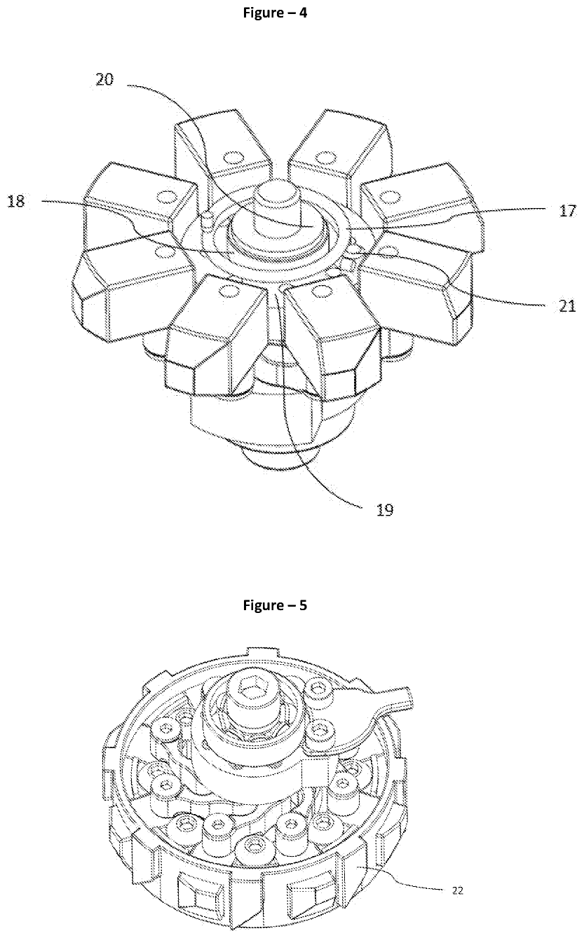

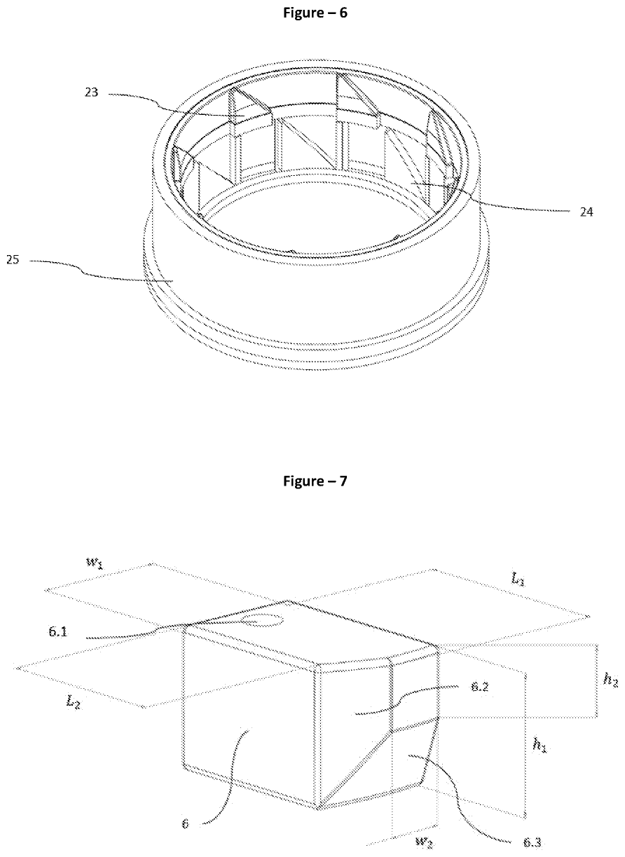

In FIG. 1, the automatic multi-bolt bayonet lock system (1), consisting of a bayonet (2) and a lock housing (3), with radial and axial locking functions, a single mechanism in the bayonet, is shown from the upper diagonal angle. In FIG. 2, the bayonet (2) consisting of the bayonet connector (4) and the locking mechanism (5) is shown from the upper and lower diagonal angles. In FIG. 3, the lock mechanism (5), consisting of the lock bolt (6), lock arm (7), lock bolt bushing screw (8), lock arm bolt (9), lock base part (10), lock central screw (11), lock pin (12), lock pin screws (13), lock mechanism central disc (14), lock upper bearing (15) and lock arm setscrews (16), is shown excluding the bayonet ring (21). In FIG. 4, the lock mechanism (5) is shown without the locking base part (10) and bayonet ring (22) in such a way that the lock spring (17), lock lower bearing (18), lock arm bearing disc (19), lock lower bearing washer (20) and lock spring connection setscrew (21) are visible. In FIG. 5, the locking mechanism (5) is shown together with the bayonet ring (22). FIG. 6 shows the lock housing (3), which consists of the lock housing upper ring (23), the lock housing lower ring (24) and the lock housing body part (25).

The lock bolt (6) shown in FIG. 7 comprises the lock bolt connection hole (6.1), laterally angled front surface (6.2) and vertically angled front surface (6.3). The function of the lock bolt (6) is to connect the bayonet (2) and the lock housing (3) together. The lock arm bolt (9) is connected to the lock bolt connection hole (6.1). The laterally angled front surface (6.2) and vertically angled front surface (6.3) enable the lock bolt (6) to slide inward as the bayonet (2) enters the lock housing (3). h₁ is the lock bolt full height, L₁ is the lock bolt full length and w₁ is the lock bolt full width. h₂ is the lock bolt cut height, L₂ is the lock bolt cut length and w₂ is the lock bolt cut width.

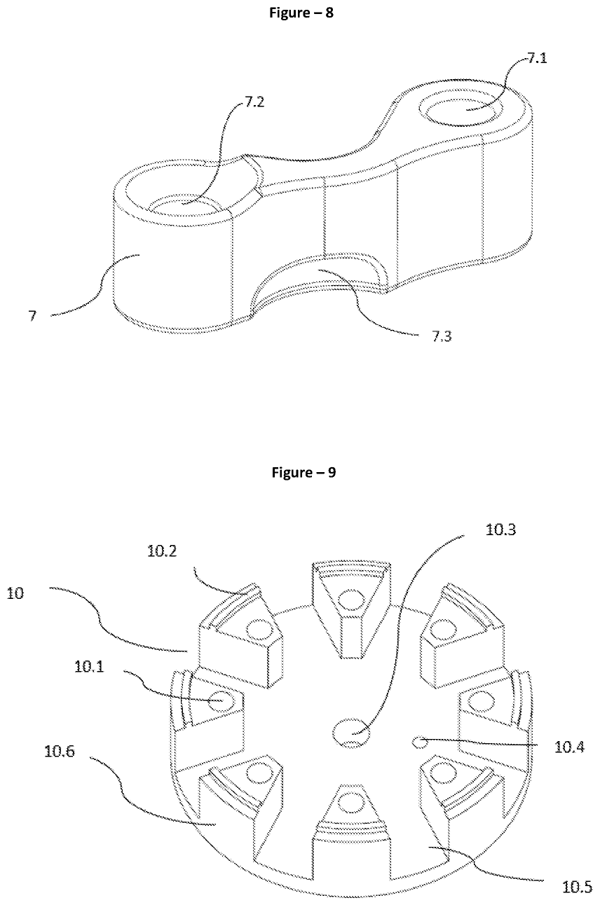

The lock arm (7) shown in FIG. 8 comprises the lock arm connection holes (7.1) (7.2), and the lock arm slot (7.3). The lock arm connection hole (7.2) is connected to the lock arm bolt (9). The lock arm connection hole (7.1) is connected to the lock arm setscrew (16). The lock arm slot (7.3) is a recess designed to prevent the lock arm (7) from hitting the lock bolt bushing screw (8).

The lock base part (10) shown in FIG. 9 comprises bushing screw holes (10.1), laser welding surface (10.2), central connection hole (10.3), spring connection hole (10.4), lock bolt housing (10.5) and base part outer surface (10.6). The lock bolt bushing screw (8) is connected to the bushing screw hole (10.1). The laser welding surface (10.2) is an elevation formed to connect the bayonet connector (4) and the lock base part (10) by laser welding. The lock central screw (11) is connected to the central connection hole (10.3). The lock spring lower pin (17.1) is connected to the spring connection hole (10.4). The lock bolt housing (10.5) serves as bedding for the lock bolts (6). The outer surface of the base part (10.6) provides the mounting surface for the bayonet ring (22).

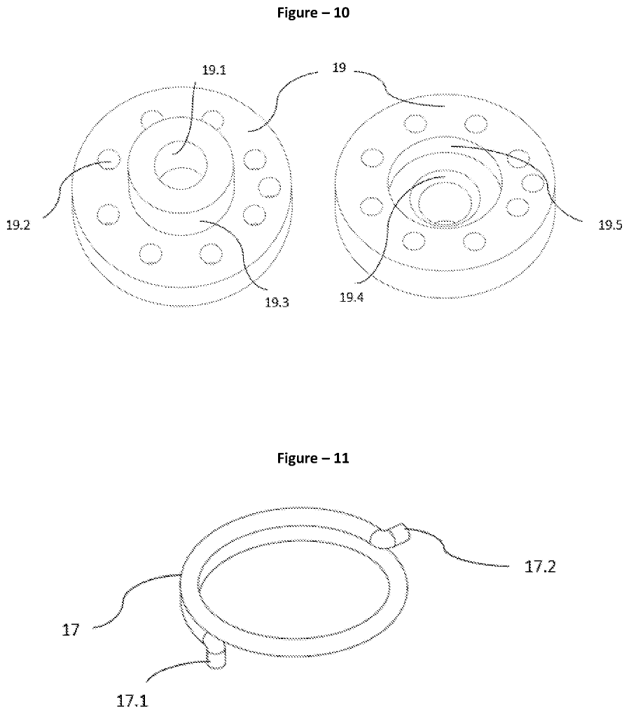

The lock arm bearing disc (19) shown in FIG. 10 comprises the central connection hole (19.1), setscrew holes (19.2), spacing shoulder (19.3), bearing countersink (19.4) and bearing housing (19.5). The central connection hole (19.1) is connected to the lock central screw (11). Lock arm setscrews (16) are connected to the setscrew holes (19.2). The lock mechanism central disc (14) contacts the spacing shoulder (19.3) by applying pressure. This spacing shoulder aims to ensure that the lock arms do not get stuck between the lock disc and the lock arm bearing disc. The bearing countersink (19.4) is formed to prevent internal contact of the lock lower bearing (18) with the lock arm bearing disc (19). The bearing housing (19.5) is formed to accommodate the lock's lower bearing (18).

The lock spring (17) shown in FIG. 11 comprises the lock spring lower pin (17.1) and the lock spring upper pin (17.2). The lock spring lower pin (17.1) is connected to the spring connection hole (10.4). The lock spring upper pin (17.2) rests on the lock spring connection setscrew (21).

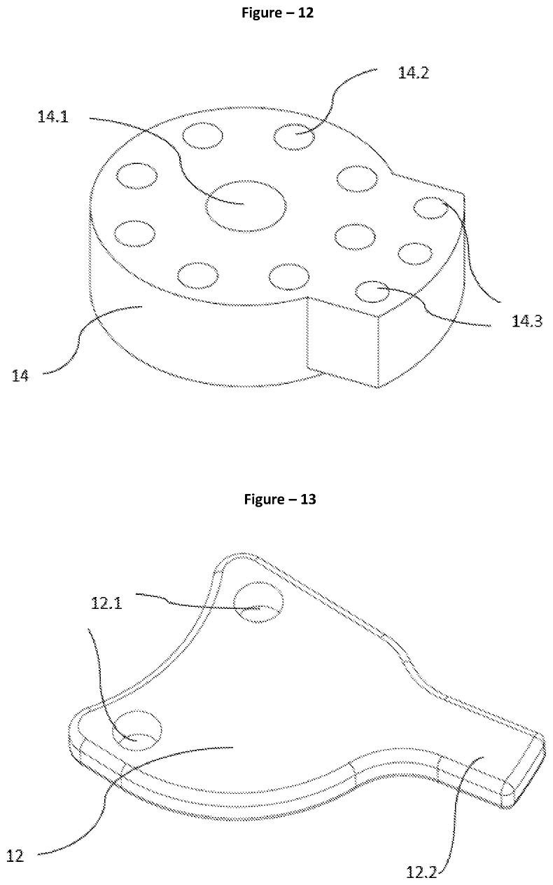

The lock mechanism central disc (14) shown in FIG. 12 comprises the central connection hole (14.1), setscrew holes (14.2), and lock pin connection holes (14.3). The central connection hole (14.1) is connected to the lock central screw (11). Setscrew holes (14.2) are connected to lock arm setscrews (16). Lock pin screws (13) are connected to the lock pin connection holes (14.3).

The lock pin (12) shown in FIG. 13 comprises lock pin connection holes (12.1) and lock pin arm (12.2). Lock pin connection holes (12.1) are connected to lock pin screws (13). The lock pin arm (12.2) comes out of the lock pin housing (4.1) and is connected to the lock holder ribs (26.1).

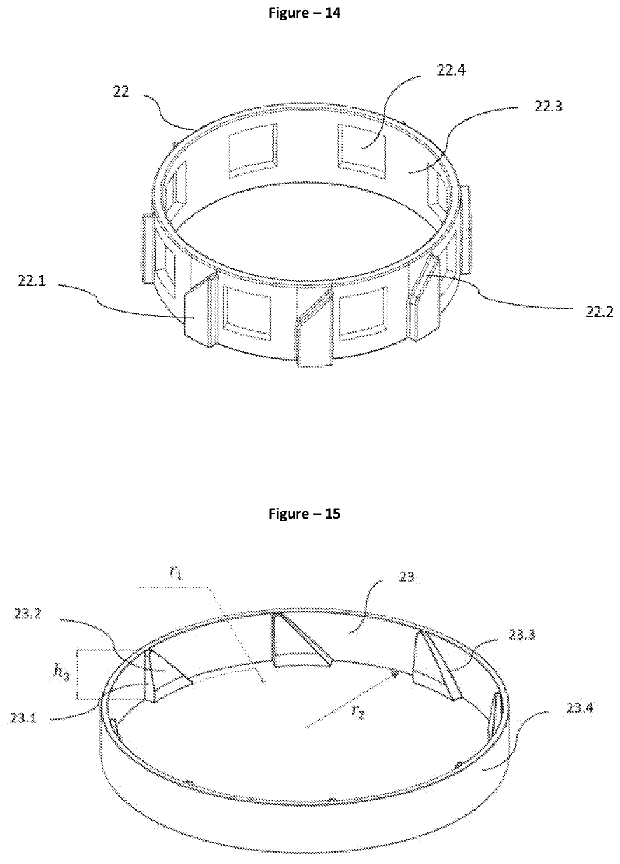

The bayonet ring (22) shown in FIG. 14 comprises lock radial fixing shoulders (22.1), lock slider lower surfaces (22.2), bayonet ring mounting surface (22.3) and lock bolt housing (22.4). The lock radial fixing shoulder (22.1) provides radial fixing by relying on the lock housing bolt side surface (25.5). The lock slider lower surfaces (22.2) provide the lock rotation function by sliding on the lock slider upper surfaces (23.3, 24.2). The bayonet ring mounting surface (22.3) is connected to the outer surface of the base part (10.6). The lock bolt housing (22.4) provides an exit opening for the lock bolt (6).

The lock housing upper ring (23), shown in FIG. 15 comprises lock housing triangular shoulders (23.1), lock housing angles (23.2), lock slider upper surfaces (23.3) and lock housing upper ring mounting surface (23.4). The lock housing triangular shoulders (23.1) serve as the body for the lock rotation function. Lock housing angles (23.2) serve as alignment aid angles for bayonet centring. The lock slide upper surfaces (23.3) provide the lock rotation function. The lock housing upper ring mounting surface (23.4) is connected to the upper inner surface (25.2) of the lock housing body part. h₃ is the lock housing upper ring height, r₁ is the lock turning inner diameter and r₂ is the lock turning outer diameter.

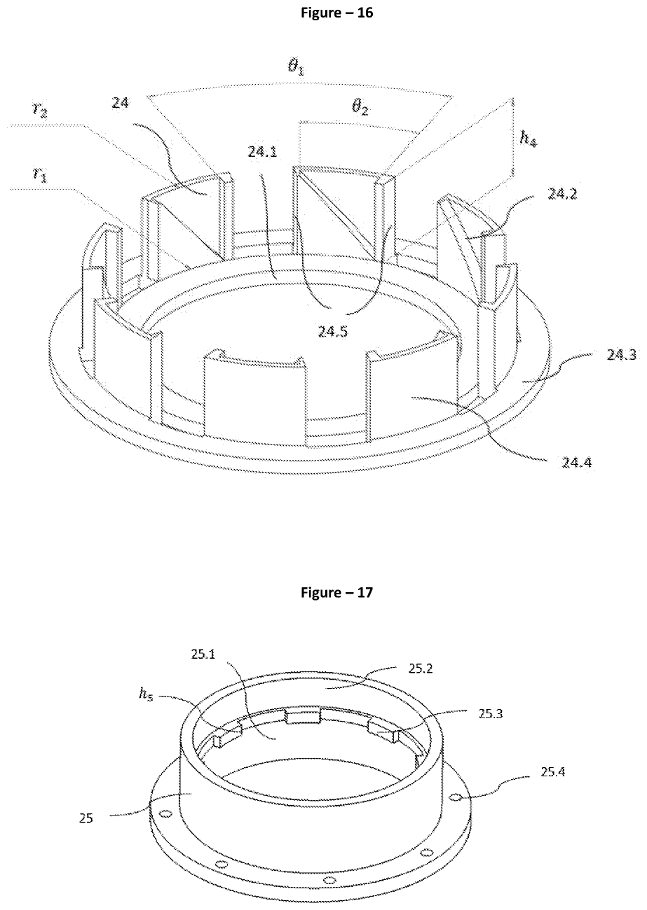

The lock housing lower ring (24) shown in FIG. 16 comprises the ring inner collet (24.1), lock slider upper surfaces (24.2), ring outer collet (24.3), lock housing lower ring mounting surface (24.4), and lock bolt bushing surfaces (24.5). The inner ring of the ring (24.1) and the outer ring of the ring (24.3) provide support for the lower ring of the lock housing (24). The lock slide upper surfaces (24.2) provide the lock rotation function. The lock housing lower ring mounting surface (24.4) is connected to the lower inner surface (25.1) of the lock housing body part. Lock bolt bushing surfaces (24.5) provide bedding function to the lock bolt (6). h₄ is the height of the lock housing the lower ring (24) excluding the inner ring of the ring (24.1) and the outer ring of the ring (24.3). θ₁ is the lock section angle, θ₂ is the lock partial angle.

Lock housing body part (25), shown in FIG. 17 comprises the lower inner surface of the lock housing body part (25.1), the upper inner surface of the lock housing body part (25.2), the lock housing bolt (25.3), the lock housing mounting holes (25.4) and the side surface of the lock housing bolt (25.5). The lower inner surface of the lock housing body part (25.1) and the upper inner surface of the lock housing body part (25.2) are surfaces created for assembly purposes. The lock housing shoulders (25.3) prevent the bayonet (2) from rising by contacting the lock bolts (6). The lock housing mounting holes (25.4) enable the lock housing (3) to be mounted by screwing it to the place where it will be used.

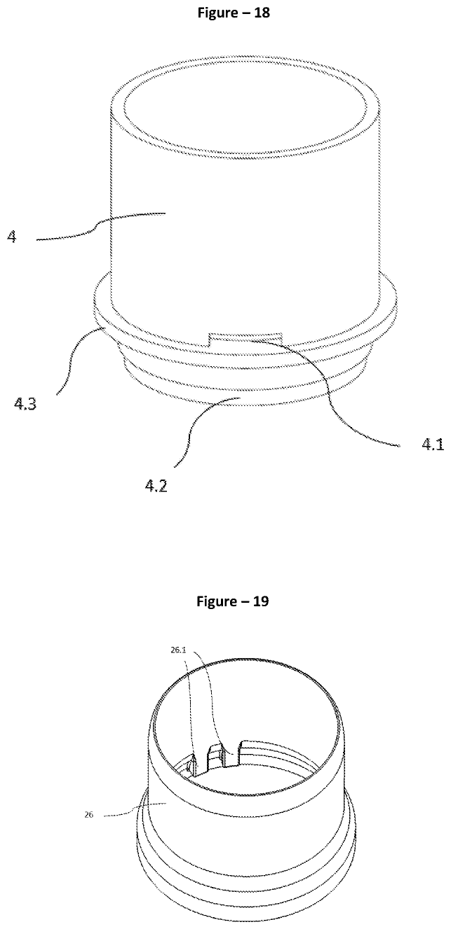

The bayonet connector (4) shown in FIG. 18 comprises the lock pin housing (4.1), the bayonet connector inserting rabbet (4.2) and the lock-facing ring (4.3). Integration of the bayonet connector (4) and the lock mechanism (5) is achieved by laser welding the bayonet connector inserting rabbet (4.2) from the inside with the laser welding surface (10.2) and the lock base part (10) from the outside. The lock-facing ring (4.3) provides the facing function by contacting the lock housing body part (25) and thus increases the static strength of the lock.

The lock holder (26) shown in FIG. 19 comprises the lock holder ribs (26.1). The lock holder ribs (26.1) enable the lock pin (12) to rotate together with the lock holder (26). In this way, when the lock holder (26) is turned by hand, the lock mechanism moves from the locked position to the unlocked position via the lock pin (12).

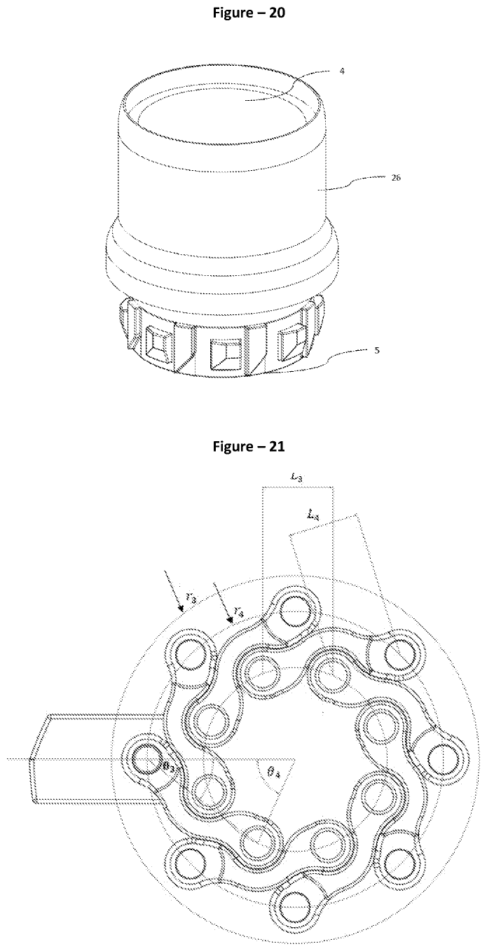

FIG. 20 shows the assembly of the lock holder (26) on the bayonet (2).

FIG. 21 shows the positions of the lock arms (7) in the unlocked position. θ₃ is the lock arm angle in the unlocked position, θ₄ is the lock pin angle in the unlocked position. L₃ and L₄ are the lock arm centre distances. r₃ is the lock arm centre radius, r₄ is the lock opening radius, and r₅ is the lock closing radius.

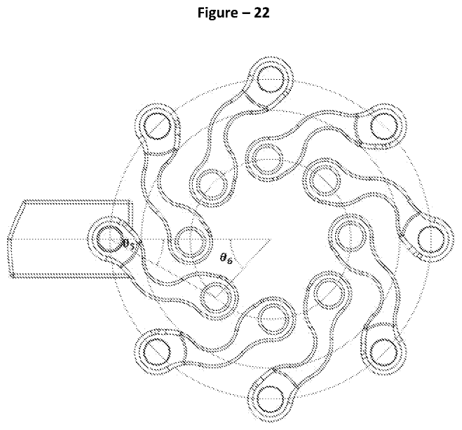

FIG. 22 shows the locked positions of the lock arms (7). θ₅ is the lock arm angle in the locked position, and θ₆ is the lock pin angle in the locked position.

The lock mechanism that is the subject of the patent has a compact structure due to the special geometry of the lock arms. To ensure this special geometry, the lengths of the lock arms (L₃ and L₄) shown in FIG. 21 must be equal. In other words, another lock arm (7) with which the lock arm connection hole (7.1) is in contact is at an equal distance from the lock arm connection holes (7.1,7.2).

The lock bolts are pushed by the lock spring through the lock arms and the lock arm bearing disc, ensuring that they remain in the locked position. While the laterally angled front surface (6.2) and vertically angled front surface (6.3) of the lock bolts are placed into the bayonet lock housing, they hit the lock housing and the lock bolts are thus pushed in. The amount of push-in is defined as the locking distance and is equal to the difference between r₄ and r₅. By pushing the lock bolts in, the lock arms move from the locked position in FIG. 22 to the unlocked position in FIG. 21. The lock arms and the lock pin rotate at a small angle during this transition. This angle is the difference between θ₃ and θ₅ for the lock arms and the difference between θ₄ and θ⁶ for the lock pin. When you want to remove the lock mechanism from the lock housing, the lock pin must be manually rotated counterclockwise by the lock holder by the difference of angles θ₄ and θ₆. The rotation direction of the lock holder can also be changed by changing the winding direction of the lock spring.

The tangent θ₇) of the surface angle of the laterally angled front surface (6.2) of the lock bolts is equal to the ratio of the difference between L₁ and L₂ to the difference between w₁ and w₂, and the tangent (θ₈) of the surface angle of the vertically angled front surface (6.3) is equal to the ratio of the difference between L₁ and L₂ to the difference between h₁ and h₂. When the width and height of the lock bolt are close to each other, θ₇ and θ₈ are close to each other. The closer the surface elevation angles (θ_{g}) of the lock sliding surfaces (22.2, 23.3 and 24.2) are to 45 degrees, the closer θ₈ and θ₉ will be to each other. These angles (θ₇ and θ₈) being smaller allows the lock bolts to be pushed into the lock more easily. When the lock bolts are pushed more easily by the lock housing manually placing the bayonet is into the lock housing, the manual force required to be applied to the bayonet is reduced and an ergonomic locking is achieved. For this ergonomics, the θ₃ and θ₅ angles of the lock arms must remain within a certain range. Although this angle range is wide, the average value for this angle range is 45 degrees.

The alignment of the lock bolts to their positions in the lock housing is achieved by the specially angled spiral surfaces of the bayonet and the lock rings (22, 23, 24) in the lock housing, and the lock slider lower surfaces (22.2) slide on the lock slider upper surfaces (23.3, 24.2) and rotate the bayonet at a small angle. The maximum value of this angle (89) is determined by the number of lock bolts (n), lock housing depth (h₆) and lock housing inner radii (r₁, r₂). The lock housing depth (h₆) value is up to h₃, h₄ and h₅. The minimum number of locking bolts is 2 and there is no theoretical upper limit. Lock housing depth and centre diameter can be determined according to the required size and without a theoretical upper/lower limit. The relationship between θ₉, n, h₆, r₁ and r₂ is expressed by the following formula:

$$tan ( {θ}_{9} ) = n ( {h}_{3} + {h}_{4} + {h}_{5} ) / π ( {r}_{1} + {r}_{1} )$$

The lock section angle θ₁ value is found by dividing 360 degrees by the number of lock bolts (n). The relationship of the lock partial angle (θ₂) with the lock section angle (θ₁) is expressed by the following formula:

$${θ}_{2} = {θ}_{1} ( {h}_{3} + {h}_{5} ) / ( {h}_{3} + {h}_{4} + {h}_{5} )$$

Although there is a wide range for this angle (θ₉), the steepness of this angle is a value that increases the ergonomics of the lock.

The manufacturing of the pointed triangular designs on the bayonet and the rings in the lock housing (22, 23, 24) is possible with 3D printing techniques, sintering or precision casting, and a manufacturing technique suitable for the selected material is preferred. While the 3D printing technique stands out for plastic materials, sintering or precision casting is more suitable for metal materials.

1. An automatic multi-bolt bayonet lock system (1) with a single mechanism in a bayonet, with a radial and axial locking function that does not require manual alignment by using the number of lock bolts and lock sliding angle appropriate to the lock diameter and depth, comprising:
at least two lock bolts (6) connecting the bayonet (2) and the lock housing (3), comprising laterally angled front surface (6.2) and vertically angled front surface (6.3), which enable the lock bolt (6) to slide inward while the bayonet (2) enters the lock housing (3) and the lock bolt connection hole (6.1) that allows the lock arm bolt (9) to be connected,
At least one lock lever (7) that controls the movement of the lock bolts, comprising lock arm slot (7.3), which ensures that the lock arm (7) does not hit the lock bolt bushing screw (8), the lock arm connection hole (7.1) connected to the lock arm setscrew (16) and the lock arm connection hole (7.2) connected to the lock arm bolt (9),
at least one lock base part (10) that accommodates the lock bolts and comprises the bushing screw hole (10.1), to which the lock bolt bushing screw (8) is connected, laser welding surface (10.2), which enables the bayonet connector (4) and the lock base part (10) to be connected by laser welding, central connection hole (10.3) to which the lock central screw (11) is connected, spring connection hole (10.4) to which the lock spring lower pin (17.1) is connected, lock bolt housing (10.5), which serves as a bedding for the lock bolts (6), and the outer surface (10.6) of the base part that provides the mounting surface for the bayonet ring (22),
at least one lock arm bearing (19), which comprises a central connection hole (19.1), connected to the lock central screw (11), setscrew holes (19.2) to which the lock arm setscrews (16) are connected, spacing shoulder (19.3), which contacts the lock mechanism central disc (14) by applying pressure and ensures that the lock arms (7) do not get stuck between the lock mechanism central disc (14) and the lock arm bearing disc (19), bearing countersink (19.4), which cuts the internal contact of the lock lower bearing (18) with the lock arm bearing disc (19), and the bearing housing (19.5) where the lock lower bearing (18) is located, and allows the lock arms to be moved manually or with the lock spring (17),
at least one lock spring (17) that comprises the lock spring lower pin (17.1) connected to the spring connection hole (10.4), and the lock spring upper pin (17.2) leaning on the lock spring connection setscrew (21) and contributes to the automatic locking function by ensuring that the lock bolts (6) remain in the locked position,
hub disc (14) that comprises central connection hole (14.1), connected to the lock central screw (11), setscrew holes (14.2) connected to the lock arm setscrews (16), and lock pin connection holes (14.3) to which the lock pin screws (13) are connected and provides top closure to the lock arms (7) connected to the lock arm bearing disc (19),
at least one lock pin (12), which comprises lock pin connection holes (12.1) connected to the lock pin screws (13) and lock pin arm (12.2) coming out of the lock pin housing (4.1) and connecting to the lock holder ribs (26.1), and acts as a motion transmitter between the lock holder (26) and the lock arm bearing disc (19),
at least one bayonet ring (22) that comprises lock radial fixing shoulder (22.1), which provides radial fixing by relying on the lock housing bolt side surface (25.5), lock slider lower surfaces (22.2) that provide the lock rotation function by sliding on the lock slider upper surfaces (23.3, 24.2), the bayonet ring mounting surface (22.3) connected to the outer surface of the base part (10.6), and the lock bolt housing (22.4) providing an exit opening for the lock bolt (6),
at least one lock housing upper ring (23) that comprises lock housing triangular shoulders (23.1) that act as bodies for the lock turning function, lock housing angles (23.2) that serve as alignment aid angles for bayonet centring, lock slider upper surfaces (23.3) that provide a lock rotation function, and a lock housing upper ring mounting surface (23.4) connected to the upper inner surface (25.2) of the lock housing body part, and that ensures the automatic alignment of the lock bolts (6) within the lock housing,
at least one lock housing lower ring (24) that comprises the inner ring of the ring (24.1) and the outer ring of the ring (24.3), which provide a bearing for the lower ring of the lock housing (24), lock slider upper surfaces (24.2), which provide a lock rotation function, lock housing lower ring mounting surface (24.4), which is connected to the lower inner surface of the lock housing body part (25.1), and lock bolt bushing surfaces (24.5) providing a bearing function to the lock bolt (6), and that ensures automatic alignment of the lock bolts within the lock housing,
at least one lock housing body part (25) comprising lock housing shoulders (25.3), which prevent the bayonet (2) from rising by contacting the lock bolts (6), lock housing mounting holes (25.4), which enable the lock housing (3) to be mounted by screwing to the place where it will be used, the lower inner surface (25.1) of the lock housing body part and the upper inner surface (25.2) of the lock housing body part formed for assembly purposes,
at least one bayonet connector (4) comprising bayonet connector inserting rabbet (4.2), which enables the integration of the bayonet connector (4) and the lock mechanism (5) by laser welding from the inner part with the laser welding surface (10.2) and from the outer part with the lock base part (10), and a lock facing ring (4.3) that provides facing function by contacting the lock housing body part (25), and a lock pin housing (4.1), and
the lock holder (26) comprising lock holder ribs (26.1) that enable the lock pin (12) to rotate together with the lock holder (26) and enable the lock to be opened manually.

2. An automatic multi-bolt bayonet locking system with radial and axial locking functions, and with a single mechanism in the bayonet, according to claim 1, wherein another lock arm (7) with which the lock arm connection hole (7.1) is in contact is at an equal distance from the lock arm connection holes (7.1,7.2).

3. An automatic multi-bolt bayonet locking system with radial and axial locking functions, and with a single mechanism in the bayonet, according to claim 1, wherein the tangent of the surface angle θ₇) of the laterally angled front surface (6.2) of the lock bolts is equal to the ratio of the difference between L₁ and L₂ to the difference between w₁ and w₂.

4. An automatic multi-bolt bayonet locking system with radial and axial locking functions, and with a single mechanism in the bayonet, according to claim 1, wherein the tangent of the surface angle (θ₈) of the angled front surface (6.3) is equal to the ratio of the difference between L₁ and L₂ to the difference between h₁ and h₂.

5. An automatic multi-bolt bayonet locking system with radial and axial locking functions, and with the single mechanism in the bayonet, according to claim 1, comprising the lock housing lower ring (24) with the lock section angle obtained by dividing 360 degrees by the number of lock bolts.

6. An automatic multi-bolt bayonet locking system with radial and axial locking functions, and with the single mechanism in the bayonet, according to claim 1, comprising a lock housing lower ring (24) with lock partial angle obtained by equation θ₂=θ₁(h₃+h₅)/(h₃+h₄+h₅).

7. An automatic multi-bolt bayonet locking system with radial and axial locking functions, and with a single mechanism in the bayonet, according to claim 1, comprising the bayonet that aligns the lock bolts to their positions in the lock housing by sliding the lock slider lower surfaces (22.2) on the lock slider upper surfaces (23.3, 24.2) and rotating the bayonet by an angle whose maximum angle value is calculated by the equation tan (θ₉)=n(h₃+h₄+h₅)/π(r₁+r₁) and the lock rings (22, 23, 24) in the lock housing.
